(19) United States
(12) Patent Application Publication
(10) Pub. No.: US 2011/0179707 A1
(43) Pub. Date: Jul. 28, 2011

(54) Sloped Slot Pot

(76) Inventor: Jefferey N. Woelfel, Coram, NY (US)

(21) Appl. No.: 12/695,120

(22) Filed: Jan. 27, 2010

(51) Int. Cl. A01G 9/02

(52) U.S. Cl. 47/65.5

(57) ABSTRACT

A horticultural sloped slot pot having an upper and lower end connected together via a wall having a height and thickness, wherein the wall extends about the perimeter of both ends wherein an axis extends radially through the ends such that the upper end is smaller than the lower end in terms of the total area, and having at least one orifice in the wall.

### BACKGROUND OF THE INVENTION

This invention relates to a horticultural container, in particular, a horticultural container being configured and dimensioned as a sloped slot pot for maximizing aesthetic effect of vegetation by minimizing aesthetic influence of said container.

Historically, horticultural containers are fabricated and sold in a plethora of shapes and sizes, typically having a wall connecting an upper and lower perimeter wherein the upper perimeter is greater than or equal to the lower perimeter. In this embodiment, the soil, the plant, and the nutrients are all accessed only via the one open end located within the upper perimeter. However, one issue with this embodiment is that the aesthetic look of the overall combination of plant and container is that the container often overpowers or comprises a substantial part of the look, both at the time of planting, and during the life cycle of the vegetation, which often defeats the purpose of having the vegetation in the first instance.

FIG. 1 illustrates which may be considered as a modification to historical pots for plants, to have one or more balcony like features about the wall of the container, however, this further exacerbates the issue of making the container more dominant to the overall aesthetic look and feel of the combined plant and container scenario. (See www.marthastewart.com/article/planting-a-strawberry-pot)

FIG. 2 illustrates which may be considered as a further attempt to modify the classical container, but in this version, a plastic bag is used to hang the vegetation on fences, porches or other supporting devices. However, a common problem with this reference is that too much water flows through the openings, and requires frequent doses of minimal watering, in addition to flooding of the flooring immediately beneath such hanging flower bag. Moreover, it is unable to support much weight, and this is typically limited to only certain outdoor uses wherein water stains and puddles are acceptable. (See http://exterior-accents.com/hagaflbasof3.html)

It is in this view that there is a need to minimize the aesthetic impact of the container by maximizing the aesthetic effect of the desired vegetation from the day of planting, while providing a strong, water and weight friendly design.

### SUMMARY OF THE INVENTION

The present invention is directed to a sloped slot pot having the primary advantage of improving the aesthetic contribution of the vegetation while minimizing the aesthetic contribution of the container, while also optimizing conditions for the vegetation.

In order to accomplish the foregoing advantage, in a first embodiment illustrated in FIG. 3, a sloped slot pot 10 having an upper and lower end 12,14 connected together via a wall 16 having a height 18 and thickness 20, wherein the wall 16 extends about the perimeter of both ends 12,14 wherein an axis A-A extends radially through the ends 12,14 such that the upper end 12 is smaller than the lower end 14 in terms of the total area (e.g., the area in square inches of the upper end 12, is less than the area of the lower end 14), for example, inter alia, a frustum shaped container, however, additional shapes are envisioned providing the relationship between upper and lower end 12,14 remains, e.g., the area of the upper end 12 is less than the area of the lower end 14, and the wall 16 is sloped towards the upper end 12 substantially in a linear path.

It is preferred that the lower end 14 is solid and closed without any orifices therein, and the upper end 12 is open, whereas the wall 16 having a least one opening therein 22, optionally, a plurality of openings, for permitting planting of additional plants therethrough, e.g., from the exterior of the wall inwardly towards the inside and/or axis of the container 10. One advantage of having the lower end 14 larger than the upper end 12, in addition to adding stability, is that when a liquid nutrient, such as water, is dispensed through the upper opening 12, the liquid nutrient, nor any thing else, preferably does not exit the container 10 via an opening 22 in the wall 16, but at least no more than a nominal amount does so. In this preferred embodiment, the tendency is for the liquid to continue primarily downwardly parallel to the axis and towards the lower end 14, largely due to the increasingly larger area therebelow. This promotes deeper root growth of both the primary plant(s) residing in the upper end, and any secondary plant(s) residing in an orifice 22 in the wall 16, wherein both instances, roots tend to migrate towards the axis and downwardly.

Although it may be otherwise, it is preferred that any orifice 22 in the wall 16 be no closer than one-half inch from the lower end 14, thereby increasing the likelihood that any liquid nutrient would not emanate therefrom 22. For example, if an orifice 22 was immediately adjacent to the lower end 14, it is highly probable, if not imminent that any liquid nutrient would be transient therethrough 22, compared to as when the orifice 22 were not. This would substantially reduce the likelihood of flushing nutrients, whether solid or liquid out. Illustrated in FIG. 4, is an alternative embodiment, wherein only one slot is needed.

Illustrated in FIG. 5, is another alternative embodiment, wherein an alternative frustum shape is embodied, namely, a pyramid-like shape.

FIG. 6 illustrates an embodiment where the device 310, when viewed from the top/bottom 312,314, is less than 360 degrees, for example, a semicircle, or 180 degrees. Specifically, wherein said pot 310 when viewed from the top 312 has a section removed in the range from about one degree to about 359 degrees. Moreover, if the optional plate (not shown) is incorporated herewith, then the plate would necessarily need to have the same amount of section removed as the pot set forth above. One reason for having a section removed is such that the pot 310 can be used to encompass the edge of something, such as a stoop. For example, a semi-circle shape can be used for each step, a full circle used on the top landing area, but a three-quarter version could be used at the bottom step's outer two edges, thus covering both the riser and the stringer side of the stoop.

Alternatively, if a 270 degree section was removed, the 90 degree portion remaining could be used for an inside corner rather than the outside corner described immediately supra.

It is envisioned that in all scenarios that the upper end is smaller than the lower end and the wall connects the two ends together, wherein the wall is substantially sloped towards the upper end, substantially linearly, wherein the polygon may have any number of sides.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates existing art, namely, a strawberry pot;

FIG. 2 illustrates existing art, namely, a hanging flower bag;

FIG. 3 illustrates a front view of a preferred embodiment of the present invention, wherein said ends are circular;

FIG. 3A illustrates a top view of FIG. 3;

FIG. 4 illustrates an alternative embodiment of the present invention, wherein only one slot is implemented;

FIG. 4A illustrates a top view of FIG. 4 supra;

FIG. 5 illustrates another alternative embodiment of the present invention, wherein said ends are an alternative frustum shape; and

FIG. 6 illustrates a further alternative embodiment of the present invention, wherein said ends are less than 360 degrees.

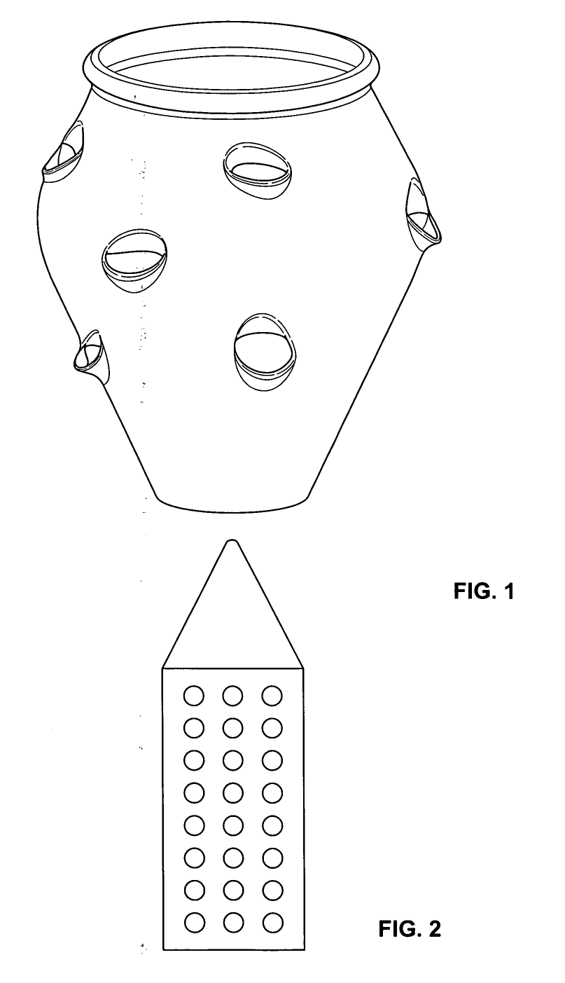

### DETAILED DESCRIPTION OF THE INVENTION

The following descriptions of the preferred embodiments are presented to illustrate the present invention and are not to be construed to limit the claims in any manner whatsoever.

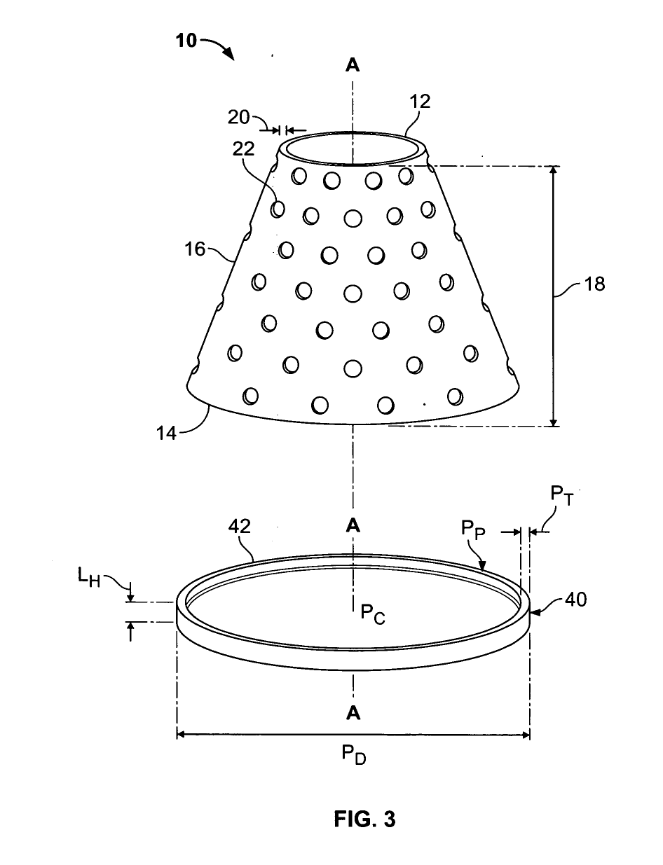

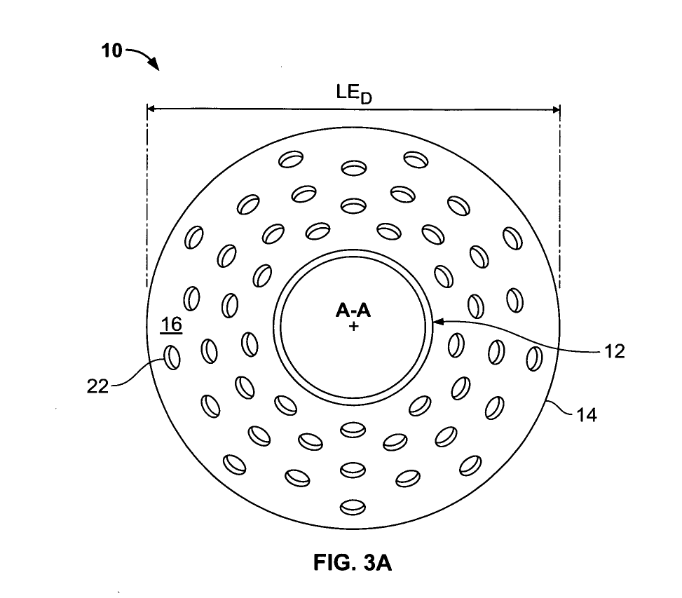

In reference to the drawings, namely FIGS. 3 to 6, FIGS. 3 to 3A illustrates a first embodiment. A sloped slot pot 10 having an upper and lower end 12,14 connected together via a wall 16 having a height 18 and thickness 20, wherein the wall 16 extends about the perimeter of both ends 12,14 wherein an axis A-A extends radially through the ends 12,14 such that the upper end 12 is smaller than the lower end 14 in terms of the total area (e.g., the area in square inches of the upper end 12, is less than the area of the lower end 14), for example, inter alia, a frustum shaped container, however, additional shapes are envisioned providing the relationship between upper and lower end 12,14 remains, e.g., the area of the upper end 12 is less than the area of the lower end 14, and the wall 16 is sloped towards the upper end 12 substantially in a linear path.

It is preferred that the lower end 14 is solid and closed without any orifices therein, and the upper end 12 is open, whereas the wall 16 having a least one opening therein 22, optionally, a plurality of openings, for permitting planting of additional plants therethrough, e.g., from the exterior of the wall inwardly towards the inside and/or axis of the container 10. One advantage of having the lower end 14 larger than the upper end 12, in addition to adding stability, is that when a liquid nutrient, such as water, is dispensed through the upper opening 12, the liquid nutrient, nor any thing else, preferably does not exit the container 10 via an opening 22 in the wall 16, but at least no more than a nominal amount does so. In this preferred embodiment, the tendency is for the liquid to continue primarily downwardly parallel to the axis and towards the lower end 14, largely due to the increasingly larger area therebelow. This promotes deeper root growth of both the primary plant(s) residing in the upper end, and any secondary plant(s) residing in an orifice 22 in the wall 16, wherein both instances, roots tend to migrate towards the axis and downwardly.

Although it may be otherwise, it is preferred that any orifice 22 in the wall 16 be no closer than one-half inch from the lower end 14, thereby increasing the likelihood that any liquid nutrient would not emanate therefrom 22. For example, if an orifice 22 was immediately adjacent to the lower end 14, it is highly probable, if not imminent that any liquid nutrient would be transient therethrough 22, compared to as when the orifice 22 were not. This would substantially reduce the likelihood of flushing nutrients, whether solid or liquid out.

Moreover, depending on the variety of vegetation that is desired will dictate the dimensions of the nature and quantity of orifices 22. for example, if only one type of plant is desired, and the age of each plant is similar to the extent of where in the product life cycle, then only one size of orifice 22 is needed, wherein the actual dimensions would be sufficient to permit the selected vegetation to reach maturity without choking the selected vegetation. Conversely, if a plurality of vegetation is desired having uncommon specifications, then a plurality of size orifices 22 would be needed each suitable for each type of vegetation. One objective is to provide enough orifices depending on the vegetation selected to cover the exterior of the wall 16.

The horticultural sloped slot pot 10 further includes a plate 40 having a body with a thickness P_{T}, a diameter P_{D} slightly larger than the diameter LE_{D} of said lower end 14, a center P_{c}, and a perimeter P_{P}, with a lip 42 extending substantially perpendicular to the perimeter P_{P}in an upwardly direction, wherein said lip 42 has a desired-height L_{H} of about one-half inch, wherein said plate 40 is positioned underneath the lower end 14, said center P_{c} in alignment with said axis A-A.

In this embodiment, the upper end 12, and lower end 14 may be either open or closed in whole or in part. Moreover; the shape of the container 10, when viewed from the top or bottom can be any shape, in this embodiment it is illustrated as a complete circle, although it may be less than 360 degrees, for example, a semicircle, or three-quarter circle or some other shape such that the device can be placed against a wall or an outside corner thereof, and likewise for the optional plate 40.

In order to assist one in the understanding of the operation of the present invention 1, it would be advantageous to consider use in practice.

Given the time of year of the drafting of this application, a conical shape comes to mind wherein a plurality of orifices 22 exist in the wall 16 thereby permitting planting of a variety of vegetation. For example, a Christmas tree can be constructed with the insertion of seedlings of fur trees, such as northeastern white pines, although any fur tree would do, with red berry plants intedispersed. When viewed as a whole, there would appear to be rows and columns or maybe a random number of rows and columns, depending on the desired effect, with possibly one red berry plant for every two pine seedlings. This might be planted in early fall so that by the time the holiday season arrives in December, the plants have taken to their new environment well enough to fill in and provide coverage of the container. Moreover, a plate 40 probably would be needed at the base or lower end 14 to capture any incidental excessive nutrients that might emanate out from an orifice 22 nearest the lower end 14.

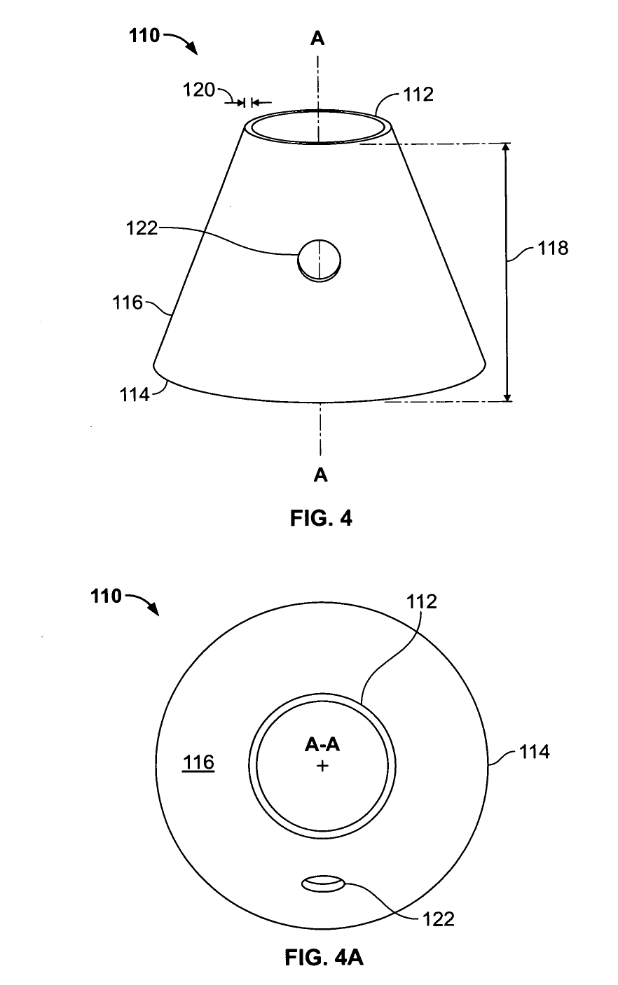

Illustrated in FIG. 4, is an alternative embodiment, wherein only one slot is needed. A sloped slot pot 110 having an upper and lower end 112,114 connected together via a wall 116 having a height 118 and thickness 120, wherein the wall 116 extends about the perimeter of both ends 112,114 wherein an axis A-A extends radially through the ends 112,114 such that the upper end 112 is smaller than the lower end 114 in terms of the total area (e.g., the area in square inches of the upper end 112, is less than the area of the lower end 114), for example, inter alia, a frustum shaped container, however, additional shapes are envisioned providing the relationship between upper and lower end 112,114 remains, e.g., the area of the upper end 112 is less than the area of the lower end 114, and the wall 116 is sloped towards the upper end 112 substantially in a linear path.

It is preferred that the lower end 114 is solid and closed without any orifices therein, and the upper end 112 is open, whereas the wall 116 having one opening therein 122, for permitting planting of additional plants therethrough, e.g., from the exterior of the wall inwardly towards the inside and/or axis of the container 110. One advantage of having the lower end 114 larger than the upper end 112, in addition to adding stability, is that when a liquid nutrient, such as water, is dispensed through the upper opening 112, the liquid nutrient, nor any thing else, preferably does not exit the container 110 via an opening 122 in the wall 116, but at least no more than a nominal amount does so. In this preferred embodiment, the tendency is for the liquid to continue primarily downwardly parallel to the axis and towards the lower end 114, largely due to the increasingly larger area therebelow. This promotes deeper root growth of both the primary plant(s) residing in the upper end, and any secondary plant(s) residing in an orifice 122 in the wall 116, wherein both instances, roots tend to migrate towards the axis and downwardly.

Although it may be otherwise, it is preferred that any orifice 122 in the wall 116 be no closer than one-half inch from the lower end 114, thereby increasing the likelihood that any liquid nutrient would not emanate therefrom 122. For example, if an orifice 122 was immediately adjacent to the lower end 114, it is highly probable, if not imminent that any liquid nutrient would be transient therethrough 122, compared to as when the orifice 122 were not. This would substantially reduce the likelihood of flushing nutrients, whether solid or liquid out.

Moreover, depending on the variety of vegetation that is desired will dictate the dimensions of the nature and quantity of orifices 122. for example, if only one type of plant is desired, and the age of each plant is similar to the extent of where in the product life cycle, then only one size of orifice 122 is needed, wherein the actual dimensions would be sufficient to permit the selected vegetation to reach maturity without choking the selected vegetation. Conversely, if a plurality of vegetation is desired having uncommon specifications, then a plurality of size orifices 122 would be needed each suitable for each type of vegetation. One objective is to provide enough orifices depending on the vegetation selected to cover the exterior of the wall 116.

The horticultural sloped slot pot 110 further includes a plate 140 having a body with a thickness P_{T}, a diameter P_{D} slightly larger than the diameter LE_{D} of said lower end 114, a center P_{c}, and a perimeter P_{P}, with a lip 142 extending substantially perpendicular to the perimeter P_{P} in an upwardly direction, wherein said lip 142 has a desired height L_{H} of about one-half inch, wherein said plate 140 is positioned underneath the lower end 114, said center P_{c} in alignment with said axis A-A.

In this embodiment, the upper end 112, and lower end 114 may be either open or closed in whole or in part. Moreover, the shape of the container 110, when viewed from the top or bottom can be any shape, in this embodiment it is illustrated as a complete circle, although it may be less than 360 degrees, for example, a semicircle, or three-quarter circle or some other shape such that the device can be placed against a wall or an outside corner thereof, and likewise for the optional plate 140.

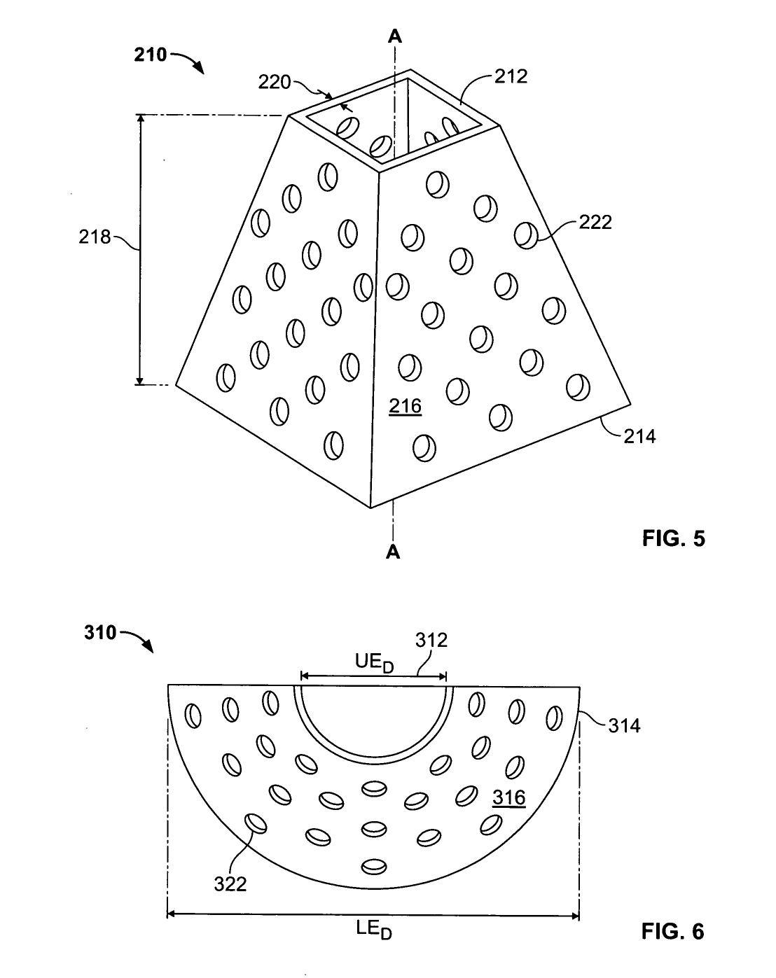

Illustrated in FIG. 5, is another alternative embodiment 210, wherein an alternative frustum shape is embodied, namely, a pyramid-like shape. A sloped slot pot 210 having an upper and lower end 212,214 connected together via a wall 216 having a height 218 and thickness 220, wherein the wall 216 extends about the perimeter of both ends 212,214 wherein an axis A-A extends radially through the ends 212,214 such that the upper end 212 is smaller than the lower end 214 in terms of the total area (e.g., the area in square inches of the upper end 212, is less than the area of the lower end 214), for example, inter alia, a frustum shaped container, however, additional shapes are envisioned providing the relationship between upper and lower end 212,214 remains, e.g., the area of the upper end 212 is less than the area of the lower end 214, and the wall 216 is sloped towards the upper end 212 substantially in a linear path.

It is preferred that the lower end 214 is solid and closed without any orifices therein, and the upper end 212 is open, whereas the wall 216 having a least one opening therein 222, optionally, a plurality of openings, for permitting planting of additional plants therethrough, e.g., from the exterior of the wall inwardly towards the inside and/or axis of the container 210. One advantage of having the lower end 214 larger than the upper end 212, in addition to adding stability, is that when a liquid nutrient, such as water, is dispensed through the upper opening 212, the liquid nutrient, nor any thing else, preferably does not exit the container 210 via an opening 222 in the wall 216, but at least no more than a nominal amount does so. In this preferred embodiment, the tendency is for the liquid to continue primarily downwardly parallel to the axis and towards the lower end 214, largely due to the increasingly larger area therebelow. This promotes deeper root growth of both the primary plant(s) residing in the upper end, and any secondary plant(s) residing in an orifice 222 in the wall 216, wherein both instances, roots tend to migrate towards the axis and downwardly.

Although it may be otherwise, it is preferred that any orifice 222 in the wall 216 be no closer than one-half inch from the lower end 214, thereby increasing the likelihood that any liquid nutrient would not emanate therefrom 222. For example, if an orifice 222 was immediately adjacent to the lower end 214, it is highly probable, if not imminent that any liquid nutrient would be transient therethrough 222, compared to as when the orifice 222 were not. This would substantially reduce the likelihood of flushing nutrients, whether solid or liquid out.

Moreover, depending on the variety of vegetation that is desired will dictate the dimensions of the nature and quantity of orifices 222. for example, if only one type of plant is desired, and the age of each plant is similar to the extent of where in the product life cycle, then only one size of orifice 222 is needed, wherein the actual dimensions would be sufficient to permit the selected vegetation to reach maturity without choking the selected vegetation. Conversely, if a plurality of vegetation is desired having uncommon specifications, then a plurality of size orifices 222 would be needed each suitable for each type of vegetation. One objective is to provide enough orifices depending on the vegetation selected to cover the exterior of the wall 216.

The horticultural sloped slot pot 210 may further include an optional a plate (not shown) as set forth supra.

In this embodiment, the upper end 212, and lower end 214 may be either open or closed in whole or in part.

FIG. 6 illustrates an embodiment where the device 310, when viewed from the top/bottom, is less than 360 degrees, for example, a semicircle, or 180 degrees, although it is envisioned the pot 310 when viewed from the top 312 has a section removed in the range from about one degree to about 359 degrees. Moreover, it is envisioned wherein the device 310 has a plurality of sides, such as, inter alia, a square, diamond, rectangle, parallelogram, or even trapezoid, which may also optionally have a section removed. Particularly, the upper and lower ends 312, 314 and the wall 316 connecting them having a plurality of orifices 322 therethrough. The upper end 312 having a diameter UE_{D} smaller than the lower end 314 LE_{D}.

Moreover, if the optional plate (not shown) is incorporated herewith, then the plate would necessarily need to have the same amount of section removed as the pot set forth above. One reason for having a section removed is such that the pot 310 can be used to encompass the edge of something, such as a stoop. For example, a semi-circle shape can be used for each step, a full circle used on the top landing area, but a three-quarter version could be used at the bottom steps outer two edges, thus covering both the riser and the stringer side of the stoop.

Alternatively, if a 270 degree section was removed, the 90 degree portion remaining could be used for an inside corner rather than the outside corner described immediately supra.

It is envisioned that in all scenarios that the upper end is smaller than the lower end and the wall connects the two together, wherein the wall is substantially sloped towards to the upper end.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. A horticultural sloped slot pot comprising:
an upper and lower end each having a diameter and a perimeter, said ends connected together via a wall having a height and thickness, wherein said wall extends about the perimeter of both ends, wherein an axis extends radially through the center of the ends, wherein the upper end is smaller than the lower end in terms of the total area, and the wall is sloped towards the upper end substantially in a linear path.

2. The horticultural sloped slot pot as in claim 1, wherein said wall further includes an orifice.

3. The horticultural sloped slot pot as in claim 2, wherein said orifice is positioned at least about one-half inch above the lower end.

4. The horticultural sloped slot pot as in claim 1, where said diameter of said upper end compared to said diameter of said lower end yields a slope m of said wall that is less than infinity (m=DELTA Y/DELTA X<∞).

5. The horticultural sloped slot pot as in claim 1, wherein said sloped slot pot is a frustum shaped container.

6. The horticultural sloped slot pot as in claim 1, further including a plate having a body with a thickness, a diameter slightly larger than the diameter of said lower end, a center, and a perimeter, with a lip extending substantially perpendicular to the perimeter in an upwardly direction, wherein said lip has a desired height, wherein said plate is positioned underneath the lower end, said center in alignment with said axis.

7. The horticultural sloped slot pot as in claim 6, wherein said height is about one-half inch.

8. The horticultural sloped slot pot as in claim 1, wherein both ends are closed, and optionally, at least one end is open.

9. The horticultural sloped slot pot as in claim 1, wherein said pot when viewed from the top has a section removed in the range from about one degree to about 359 degrees.

10. A horticultural sloped slot pot comprising:
an upper and lower end each having a diameter and a perimeter, said ends connected together via a wall having a height and thickness, wherein said wall extends about the perimeter of both ends, wherein an axis extends radially through the center of the ends, wherein the upper end is smaller than the lower end in terms of the total area, and the wall is sloped towards the upper end substantially in a linear path.

11. The horticultural sloped slot pot as in claim 1, wherein said wall further includes a plurality of orifices.

12. The horticultural sloped slot pot as in claim 11, wherein each orifice is positioned at least about one-half inch above the lower end.

13. The horticultural sloped slot pot as in claim 10, where said diameter of said upper end compared to said diameter of said lower end yields a slope m of said wall that is less than infinity (m=DELTA Y/DELTA X<∞).

14. The horticultural sloped slot pot as in claim 10, wherein the shape of said sloped slot pot is selected from the group comprising a frustum shaped container, and a three-dimensional polygon.

15. The horticultural sloped slot pot as in claim 10, further including a plate having a body with a thickness, a diameter slightly larger than the diameter of said lower end, a center, and a perimeter, with a lip extending substantially perpendicular to the perimeter in an upwardly direction, wherein said lip has a desired height, wherein said plate is positioned underneath the lower end said center in alignment with said axis; wherein said height is about one-half inch, and optionally, wherein said plate when viewed from the top has a section removed in the range from about one degree to about 359 degrees.

16. The horticultural sloped slot pot as in claim 10, wherein at least one end is closed.

17. The horticultural slope slot pot as in claim 10, wherein said pot when viewed from the top has a section removed in the range from about one degree to about 359 degrees.

18. A horticultural sloped slot pot comprising:
an upper and lower end each having a diameter and a perimeter, said ends connected together via a wall having a height and thickness, wherein said wall extends about the perimeter of both ends, wherein an axis extends radially through the center of the ends, wherein the upper end is smaller than the lower end in terms of the total area, and the wall is sloped towards the upper end substantially in a linear path; wherein said upper end optionally has at least one opening therein; wherein said lower end optionally has at least one opening therein;
wherein said wall further includes a plurality of orifices positioned at least about one-half inch above the lower end; and
where said diameter of said upper end compared to said diameter of said lower end yields a slope m of said wall that is less than infinity (m=DELTA Y/DELTA X<∞).

19. The horticultural sloped slot pot as in claim 18, further including a plate having a body with a thickness, a diameter slightly larger than the diameter of said lower end, a center, and a perimeter, with a lip extending substantially perpendicular to the perimeter in an upwardly direction, wherein said lip has a desired height, wherein said plate is positioned underneath the lower end said center in alignment with said axis; wherein said height of said lip is about one-half inch.
